(19) United States
(12) Patent Application Publication
(10) Pub. No.: US 2006/0125134 A1
(43) Pub. Date: Jun. 15, 2006

(54) Method for manufacturing a double-layer foamed sole

(76) Inventor: Chung Hsin Lin, Taichung (TW)

Correspondence Address: LIN CHUNG HSIN, P.O. BOX 2103, TAICHUNG, TW

(21) Appl. No.: 11/183,946

(22) Filed: Jul. 19, 2005

(30) Foreign Application Priority Data
Dec. 13, 2004 (CN) 2004100939124

(51) Int. Cl. B29C 44/04

(52) U.S. Cl. 264/45.1; 264/321

(57) ABSTRACT

A method for manufacturing a double-layer foamed sole, in which the mold is composed of an upper mold section, a middle mold section and a lower mold section. The upper, middle and lower mold sections respectively define therebetween an upper mold cavity and a lower mold cavity. Two different kinds of foam materials with equal foaming magnification are respectively placed into the upper and lower mold cavities. Then the mold is closed and heated to foam and mold the different foam materials in the upper and lower mold cavities into an upper layer of the sole and a lower layer of the sole. Then the mold is opened to remove the middle mold section and then the upper and lower mold sections are mated, whereby the upper layer and the lower layer are attached to each other to form the sole. Then the sole is secondarily heated up to 150° C.˜180° C. to integrally combine the different foam materials. Then the mold is totally opened to have the product of the double-layer foamed sole.

### BACKGROUND OF THE INVENTION

The present invention is related to a technique for making a sole from foam materials, and more particularly to a method for manufacturing a double-layer foamed sole at one time.

A conventional foam rubber sole is made in such a manner that a foam material is manually placed into a mold or injected by an injection apparatus into a mold. The mold is heated to a maturation temperature and then opened. At this time, the foam material will foam in the mold to become a lightweight and soft sole.

The above sole is made of single foam material so that the entire sole has uniform softness. However, in some cases, two faces of the sole must have different hardness. For example, a slipper must have a harder and antiwear bottom face and a softer top face for comfortableness. Apparently, the sole made of the single foam material cannot meet such requirement.

To solve the above problem, two kinds of foam materials with different hardness can be respectively foamed and then adhered to each other to form a sole. However, the two sole sections are easy to detach from each other after a period of use. Alternatively, two different colors of foam materials can be sequentially injected into the mold to form an inner layer of sole and an outer layer of sole. However, the later injected foam material often spills and infiltrates into the earlier injected foam material. As a result, the boundary between the inner and outer layers of the sole will be irregular (so-called spilling color). This will affect the fineness of the shoe product. Moreover, the attaching faces of the two layers of the sole can hardly reliably bonded with each other.

### SUMMARY OF THE INVENTION

It is therefore a primary object of the present invention to provide a method for manufacturing a double-layer foamed sole. The mold is composed of an upper mold section, a middle mold section and a lower mold section. The upper, middle and lower mold sections respectively define therebetween an upper mold cavity and a lower mold cavity. Two different kinds of foam materials with equal foaming magnification are respectively placed into the upper and lower mold cavities. Then the mold is closed and heated to foam and mold the different foam materials in the upper and lower mold cavities into an upper layer of the sole and a lower layer of the sole. Then the mold is opened to remove the middle mold section and then the upper and lower mold sections are mated, whereby the upper layer and the lower layer are attached to each other to form the sole. Then the sole is secondarily heated up to 150° C.˜180° C. to integrally combine the different foam materials. Then the mold is totally opened to have the product of the double-layer foamed sole.

According to the above object, the method for manufacturing the double-layer foamed sole of the present invention includes steps of:
a. opening a mold composed of an upper mold section, a middle mold section and a lower mold section, the middle mold section being disposed between the upper and lower mold sections, the upper mold section and the middle mold section defining therebetween an upper mold cavity, the middle mold section and the lower mold section defining therebetween a lower mold cavity;
b. respectively placing two different kinds of foam materials into the upper mold cavity and lower mold cavity and then closing the mold, the two kinds of foam materials having equal foaming magnification;
c. heating the mold to foam and mold the different foam materials in the upper mold cavity and the lower mold cavity into an upper layer of the sole and a lower layer of the sole;
d. opening the mold and removing the middle mold section and then mating the upper mold section with the lower mold section, whereby the upper layer and the lower layer are attached to each other to form the sole with a clear boundary between the upper and lower layers;
e. secondarily heating the sole up to 150° C.˜180° C. and maturing the sole, whereby the different foam materials are combined into an integral body; and
f. totally opening the mold to have the product of the sole.

The present invention can be best understood through the following description and accompanying drawings wherein:

### BRIEF DESCRIPTION OF THE DRAWINGS

FIG. 1A is a sectional view of the mold of the present invention;

FIG. 1B is a sectional view according to FIG. 1A, in which the mold is closed;

FIG. 2 is a sectional view according to FIG. 1B, in which different foam materials are filled into upper and lower mold cavities of the mold;

FIG. 3 is a sectional view showing that the mold is opened to remove the middle mold section;

FIG. 4 is a sectional view showing that the upper and lower mold sections are mated to combine the upper and lower layers of the sole;

FIG. 5 shows the double-layer foamed sole of the present invention;

FIG. 6 shows another aspect of the double-layer foamed sole of the present invention; and

FIG. 7 shows a second embodiment of the double-layer foamed sole of the present invention.

### DETAILED DESCRIPTION OF THE PREFERRED EMBODIMENTS

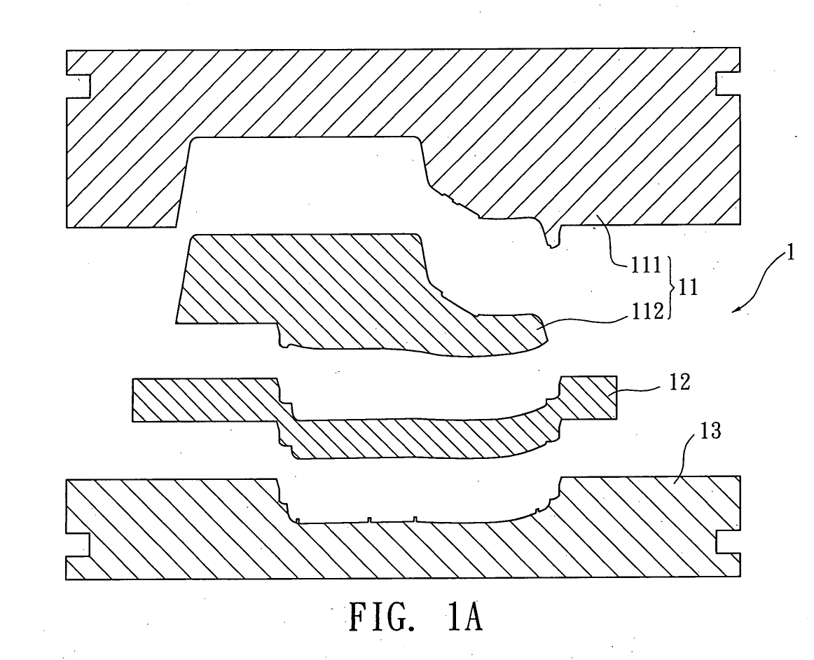

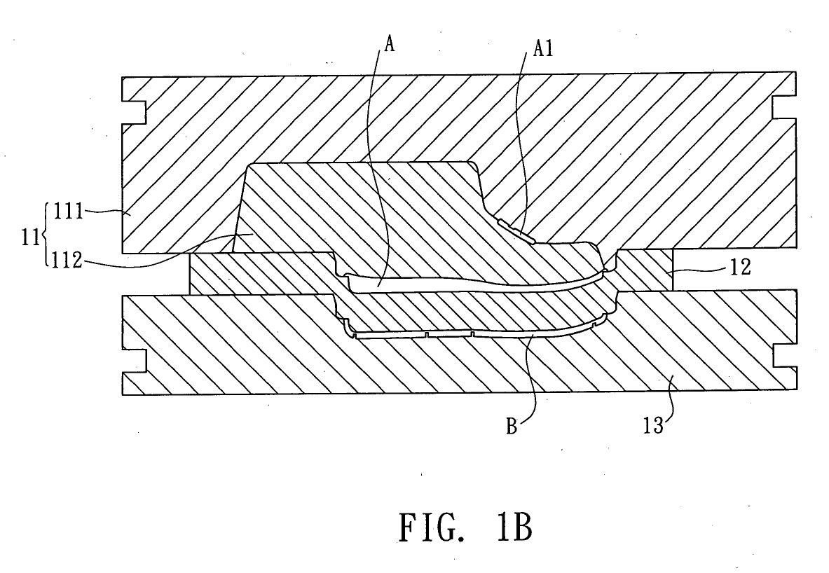

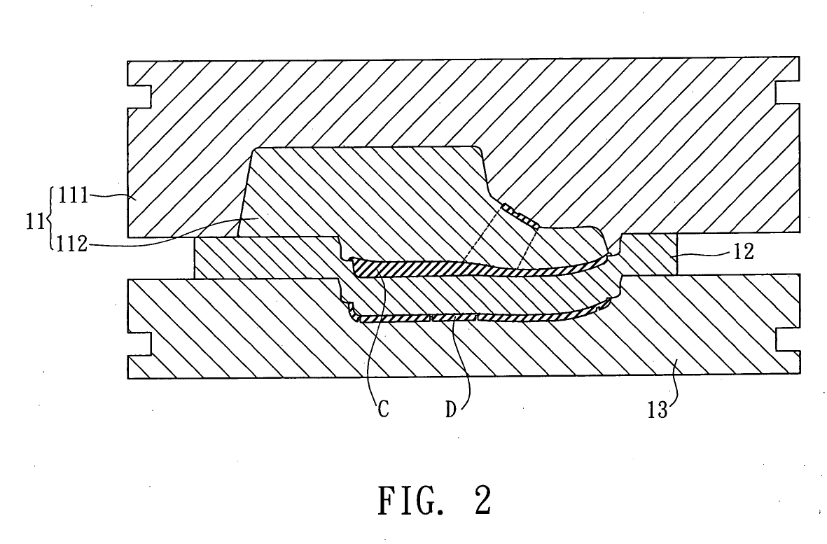

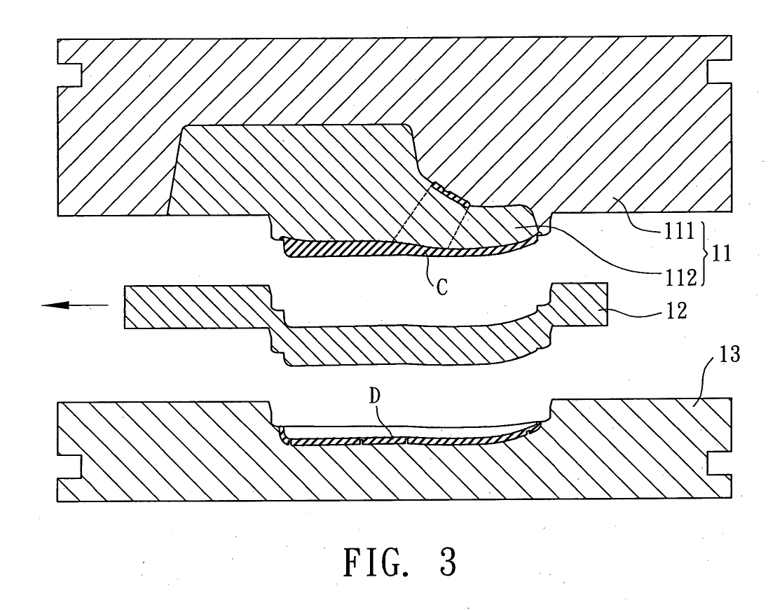

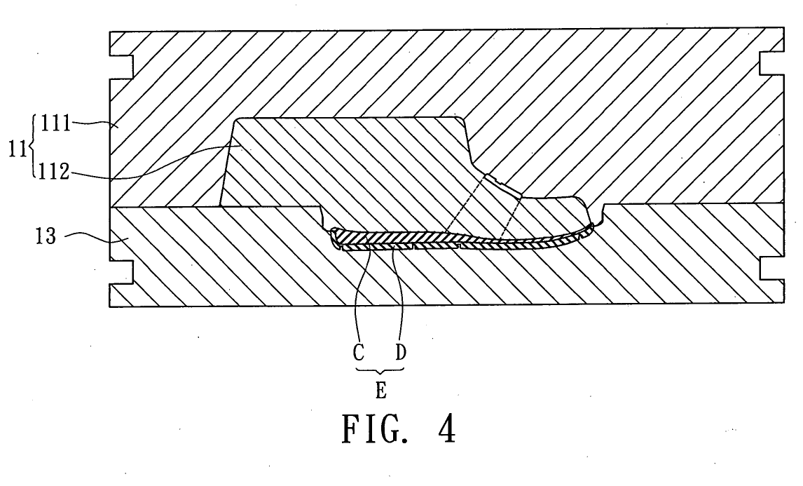

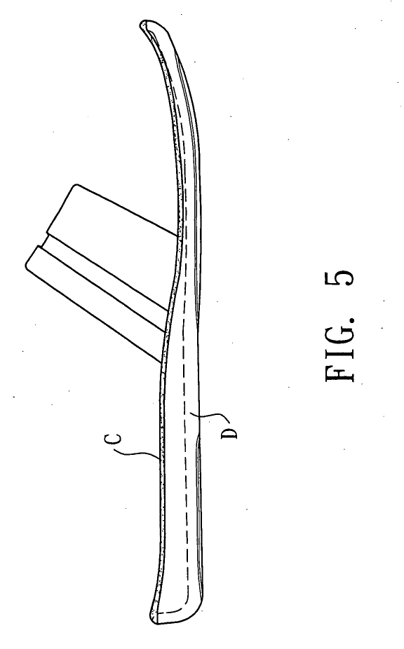

Please refer to FIGS. 1A to 5. The method for manufacturing the double-layer foamed sole of the present invention includes steps of:
a. opening a mold 1 composed of an upper mold section 11, a middle mold section 12 and a lower mold section 13, the middle mold section 12 being disposed between the upper and lower mold sections 11, 13, the upper mold section 11 and the middle mold section 12 defining therebetween an upper mold cavity A, the middle mold section 12 and the lower mold section 13 defining therebetween a lower mold cavity B, the upper mold section 11 being composed of an upper die 111 and a lower die 112 as shown in FIG. 1A, the upper die 111 and the lower die 112 defining therebetween a holder mold cavity A1, after the upper and lower dies 111, 112 and the middle mold section 12 are mated with each other, the upper mold cavity A and the holder mold cavity A1 together forming a mold cavity with a holder space as shown in FIG. 1B;
b. manually placing or mechanically injecting a kind of foam material into the upper mold cavity A and holder mold cavity A1 and manually placing or mechanically injecting another kind of foam material into the lower mold cavity B, then the entire mold 1 being closed as shown in FIG. 2, in this embodiment, the foam material injected into the upper mold cavity A and holder mold cavity A1 having lower hardness after foamed, while the foam material injected into the lower mold cavity B having higher hardness after foamed, the two kinds of foam materials having equal foaming magnification;
c. heating the mold 1 to foam and mold the different foam materials in the upper mold cavity A and holder mold cavity A1 and the lower mold cavity B into an upper layer C of the sole and a lower layer D of the sole;
d. opening the mold 1 and removing the middle mold section 12 as shown in FIG. 3 and then mating the upper mold section with the lower mold section, whereby the molded upper layer C and the lower layer D are attached to each other to form the sole E as shown in FIG. 4, the boundary between the upper and lower layers C, D being straight, arced or waved in accordance with the profile of the mold;
e. secondarily heating the sole E up to 150° C.˜180° C. and maturing the sole E, whereby the different foam materials are combined into an integral body; and
f. totally opening the mold to have the product of the sole as shown in FIG. 5.

According to the above method, the upper layer C and the lower layer D are respectively foamed and molded and then combined to form the sole E. Therefore, the boundary between the upper and lower layers C, D is clearly presented. In addition, the lower layer is made of harder foam material so that the lower layer has antiwear performance. The upper layer is made of soft foam material so that a user will feel comfortable when wearing the slipper.

Alternatively, the foam materials of the upper and lower layers can have different colors so as to achieve a beautified appearance of the sole.

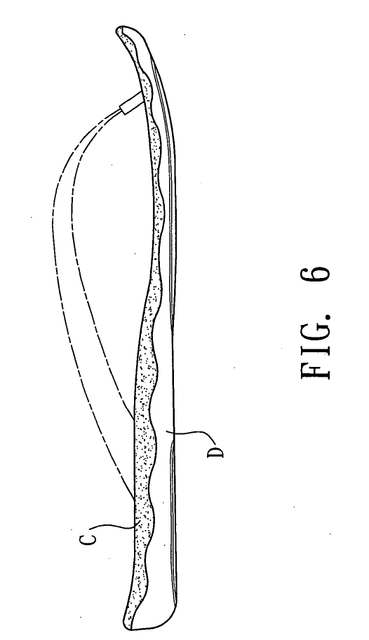

Still alternatively, the upper mold section can be a one-piece mold section. That is, the upper mold cavity is free from the holder mold cavity for forming a simple sole as shown in FIG. 6. A holder (as shown by phantom line) can be additionally disposed on the sole. The boundary between the upper and lower layers C, D of the sole still can be modified such as waved to achieve various appearances.

In conclusion, by means of the method of the present invention, a double-layer foamed sole can be integrally made with both antiwear capacity and comfortableness. In addition, the sole can have better appearance.

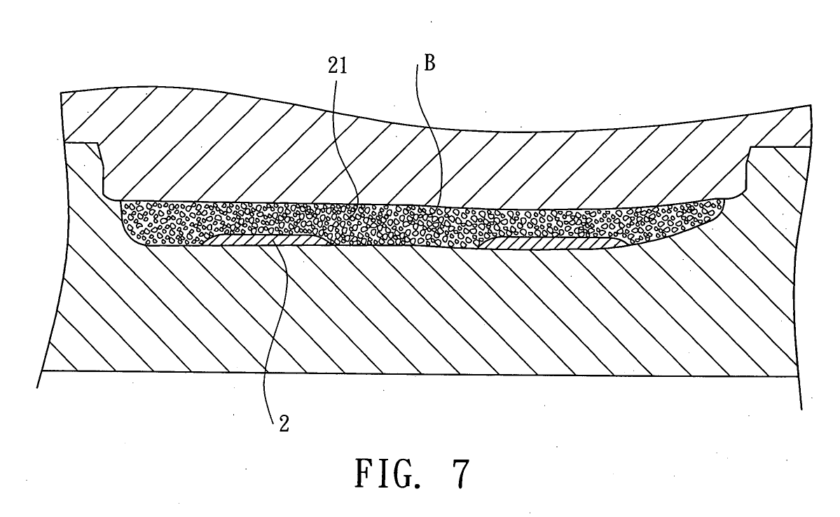

FIG. 7 shows a second embodiment of the present invention, in which sheet materials 2 are previously placed into the lower mold cavity B and then a kind of foam granules 21 are filled into the lower mold cavity as shown in FIG. 7. Another kind of foam material is placed into the upper mold cavity. Accordingly, the sole is made from three kinds of materials. This can achieve the same effect as the first embodiment.

The above embodiments are only used to illustrate the present invention, not intended to limit the scope thereof. Many modifications of the above embodiments can be made without departing from the spirit of the present invention.

What is claimed is:

1. A method for manufacturing a double-layer foamed sole, comprising steps of:
a. opening a mold composed of an upper mold section, a middle mold section and a lower mold section, the middle mold section being disposed between the upper and lower mold sections, the upper mold section and the middle mold section defining therebetween an upper mold cavity, the middle mold section and the lower mold section defining therebetween a lower mold cavity;
b. respectively placing two different kinds of foam materials into the upper mold cavity and lower mold cavity and then closing the mold, the two kinds of foam materials having equal foaming magnification;
c. heating the mold to foam and mold the different foam materials in the upper mold cavity and the lower mold cavity into an upper layer of the sole and a lower layer of the sole;
d. opening the mold and removing the middle mold section and then mating the upper mold section with the lower mold section, whereby the upper layer and the lower layer are attached to each other to form the sole with a clear boundary between the upper and lower layers;
e. secondarily heating the sole up to 150° C.˜180° C. and maturing the sole, whereby the different foam materials are combined into an integral body; and
f. totally opening the mold to have the product of the sole.

2. The method for manufacturing the double-layer foamed sole as claimed in claim 1, wherein the two kinds of foam materials have different hardness after foamed.

3. The method for manufacturing the double-layer foamed sole as claimed in claim 1, wherein the two kinds of foam materials have different colors.

4. The method for manufacturing the double-layer foamed sole as claimed in claim 1, wherein in step b, the foam materials are manually placed or mechanically injected into the upper and lower mold cavities.

5. The method for manufacturing the double-layer foamed sole as claimed in claim 1, wherein in step b, sheet materials are previously placed into the lower mold cavity and then a kind of foam granules are filled into the lower mold cavity and another kind of foam material is placed into the upper mold cavity, whereby the sole is made from three kinds of materials.

6. The method for manufacturing the double-layer foamed sole as claimed in claim 1, wherein the upper mold section is composed of an upper die and a lower die, the upper die and the lower die defining therebetween a holder mold cavity, whereby after the upper and lower dies and the middle mold section are mated with each other, the upper mold cavity and the holder mold cavity together form a mold cavity with a holder space.
